(19) United States
(12) Patent Application Publication
(10) Pub. No.: US 2009/0138482 A1
(43) Pub. Date: May 28, 2009

(54) Law enforcement data management techniques

(76) Inventor: Keith Singleton, Sunbury, OH (US)

Correspondence Address: KRIEG DEVAULT LLP, ONE INDIANA SQUARE, SUITE 2800, INDIANAPOLIS, IN, 46204-2079, US

(21) Appl. No.: 12/218,229

(22) Filed: Jul. 11, 2008

Related U.S. Application Data
(63) Continuation of application No. 11/059,426, filed on Feb. 16, 2005, now abandoned.

(51) Int. Cl. G06F 17/30

(52) U.S. Cl. 707/10; 707/E17.001; 707/E17.032

(57) ABSTRACT

A system of the present invention includes a server operable to communicate with the data access device carried in the law enforcement vehicle to request and display information about a person subject to investigation. This server is responsive to the data access device to retrieve a number of records corresponding to the person, provide a data arrangement that links a group of the records together and an identifier for such arrangement, and selectively accesses at least one member of the group of the records in response to an input from the data access device.

### BACKGROUND

The present invention relates to data processing, and more particularly, but not exclusively, relates to the management of data provided to law enforcement vehicles.

Law enforcement vehicles with mobile data terminals have become commonplace. These terminals are typically used to retrieve available records based on an input identifying a person, vehicle, or the like. One drawback of these systems is that the ability to provide meaningful information is often limited to only one or a few databases. Furthermore, when several records are available for a given person, organizing these records in a meaningful way can be difficult. Also, the ability to quickly navigate through returned records is sometimes cumbersome. Thus, there is a need for further contributions in this technology area.

### SUMMARY

One embodiment of the present application is a unique data processing technique. Other embodiments include unique methods, systems, devices, and apparatus for processing data accessible from a law enforcement vehicle.

A further embodiment of the present application includes: providing an input to a data access device to request information about a person; in response to this input, receiving a number of records corresponding to the person; providing a data arrangement that links a group of the records together; presenting an identifier for the data arrangement with the data access device; and selectively accessing at least one member of the group linked by the data arrangement. In one form, a law enforcement officer selects the person as part of an investigation, such as a traffic stop or the like; and the data access device is carried in a law enforcement vehicle. The records each may be provided from a different one of a number of remote databases.

Another embodiment includes: receiving a plurality of requests directed to investigation of a respective one of a number of people; providing a respective one of a corresponding number of data objects that are each specific to one of the people; linking two or more records specific to each person in a respective one of the data objects; presenting an identifier for the respective one of the data objects to a user through the data access device; and selecting one or more records linked by the respective one of the data objects. In one form, the data access device is carried in a law enforcement vehicle and the two or more records corresponding to a respective one of the data objects are each provided from a different one of a number of databases.

Yet another embodiment of the present invention includes logic carried with a device that is executable by a processor. This logic responds to each of a plurality of requests that are directed to investigation of a respective one of a number of people. The logic further provides a respective one of a corresponding number of data structures and links two or more records specific to the respective one of the people in such structure. Furthermore, the logic provides an identifier for the respective one of the data structures to a user through a data access device carried in the vehicle, and responds to input from the data access device by providing one or more records linked in the respective one of the data structures.

One object of the present invention is to provide a unique data processing technique.

Other objects include providing a unique method, system, device, or apparatus for processing data accessed from a law enforcement vehicle.

Further objects, embodiments, forms, aspects, benefits, advantages, and features of the present application and its inventions will become apparent from the figures and description provided herewith.

### BRIEF DESCRIPTION OF THE DRAWINGS

FIG. 1 is a diagrammatic view of a law enforcement data communication system.

FIG. 2 is a diagrammatic view of a data access device included in the system of FIG. 1.

FIGS. 3A and 3B provide a flowchart of a procedure performed with the system of FIG. 1.

FIG. 4 provides a flowchart of one procedure for reviewing linked records of an electronic jacket.

FIGS. 5-9 depict Graphical User Interface (GUI) displays that can be used to implement selected aspects of the procedures of FIGS. 3A, 3B, and 4.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

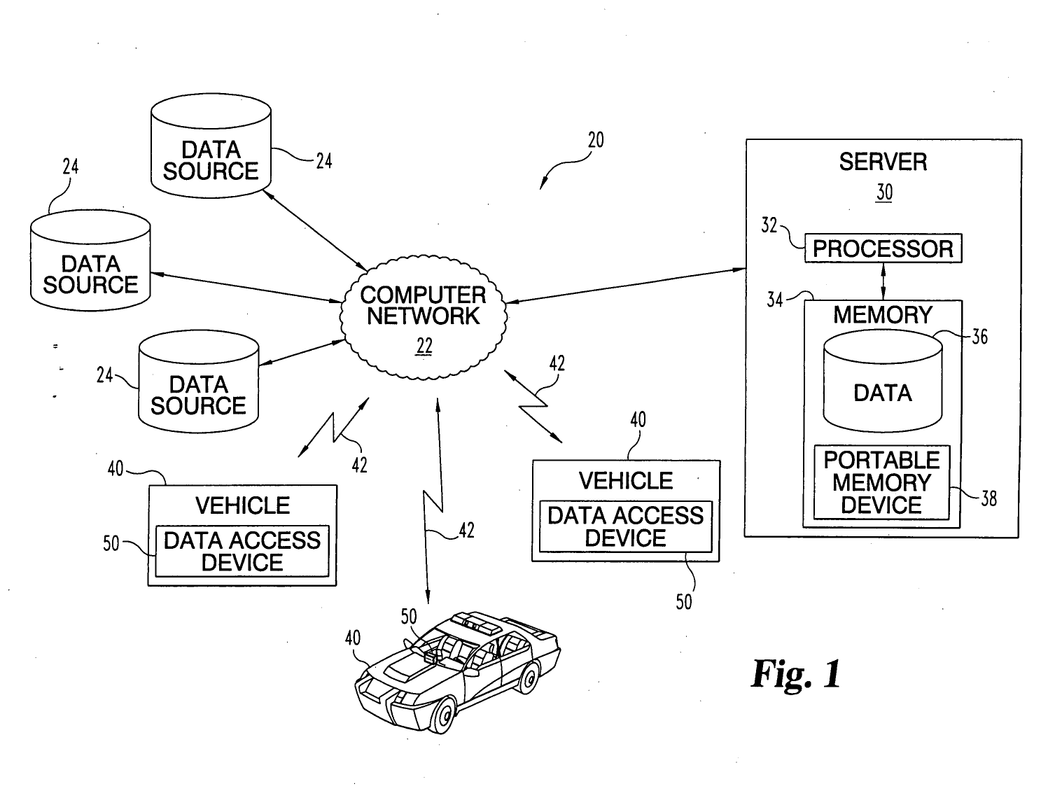

FIG. 1 diagrammatically depicts law enforcement data communication system 20. System 20 includes computer network 22, data sources 24, server 30 and law enforcement vehicles 40. Each of vehicles 40 carries mobile data access device 50. Data access devices 50 are in communication with computer network 22 by corresponding wireless links symbolically designated by reference numeral 42. Computer network 22 is also in communication with data sources 24 and server 30 by wired and/or wireless connection. Accordingly, computer network 22 can include wired connections, wireless connections, or a combination of these. Further, computer network 22 can be of one or more types, including a Local Area Network (LAN); Municipal Area Network (MAN); Wide Area Network (WAN), such as the Internet; another type as would occur to those skilled in the art; or a combination of these. Also, computer network 22 can be of a private, access-controlled variety, publicly accessible variety, or a combination of these varieties.

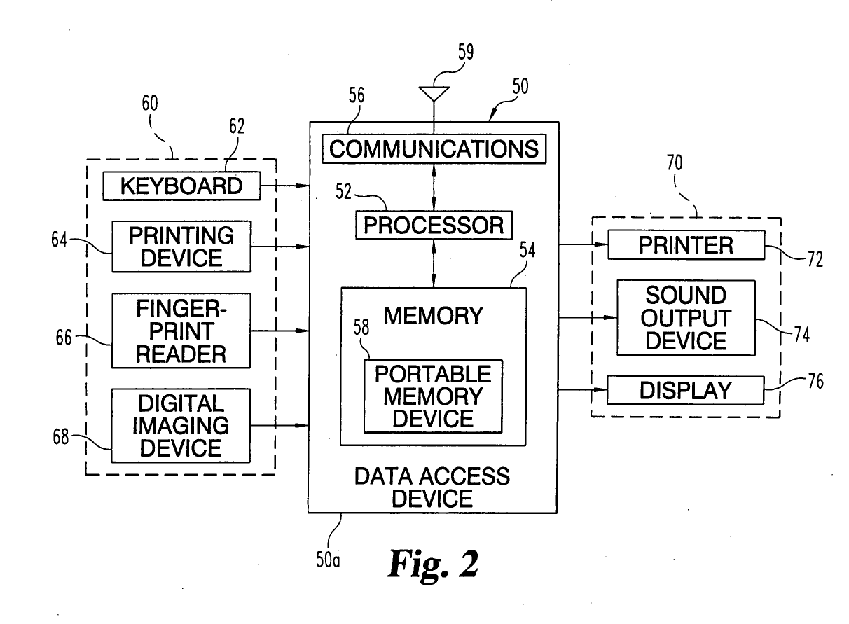

Server 30 includes processor 32 operatively coupled to memory 34. Memory 34 includes data storage as symbolically designated by reference numeral 36, and portable memory device 38. Server 30 also includes appropriate input/output devices, communication interfaces, and the like of a standard type (not shown) to facilitate communication with computer network 22. These interfaces and devices can include one or more of those specifically described in connection with FIG. 2 hereinafter. Further, such devices can be used for administrative control and monitoring of server 30, and/or such operations can be performed with a different arrangement. In one further embodiment, a cluster of multiple servers, arranged in a standard manner, is utilized in place of server 30 to enhance performance and/or reliability (not shown). Alternatively or additionally, multiple server arrangements can be employed with all servers located at a common facility or one or more of the servers remotely located relative to one or more others.

Referring additionally to FIG. 2, data access device 50 is depicted in greater detail. Device 50 includes processor 52, memory 54, and wireless communications interface 56. Memory 54 is operatively coupled to processor 52 and includes portable memory device 58. Wireless communications interface 56 is coupled to antenna 59 to wirelessly communicate with network 22 via a corresponding wireless link 42. Typically, this wireless communication is to one or more wireless network receiving stations coupled to the internet.

As shown in FIG. 2, input devices 60 and output devices 70 are operatively coupled to device 50. Input devices 60 include keyboard 62, pointing device 64 (such as a trackball, digital pen, joystick, mouse, or the like), fingerprint reader 66, and digital imaging device 68 to input still or video image information and/or one or more different input device types as would occur to those skilled in the art. Output devices 70 include printer 72; sound output device 74, such as one or more loudspeakers; and display 76, such as a color or noncolor plasma, Cathode Ray Tube (CRT), or Liquid Crystal Display (LCD) type; and/or one or more different output device types as would occur to those skilled in the art. Further, in other embodiments, more or fewer operator input devices 60 or operator output devices 70 may be utilized, and/or may be of different types. By way of nonlimiting example, a graphic display presented with display 76 can depict a keyboard graphic with software buttons corresponding to the keys. These buttons can be selected/activated with a mouse, joystick, light pen, or other pointing device using standard techniques. This software-based virtual keyboard can be used as an alternative or addition to an actual keyboard device, such as keyboard 62. Also, a voice command input can be utilized via one or more microphones included in input devices 60 (not shown).

Processor 32 and 52 each perform operations in accordance with programming instructions and/or another form of operating logic, and more particularly are each of a type suitable to perform operations described hereinafter. By way of nonlimiting example, processor 32 and/or 52 can be based on analog circuitry, digital circuitry, or a combination of such circuitry. In one form, processor 32 and/or 52 is integrated circuit based, including one or more digital, solid-state central processing units each in the form of a microprocessor. It should be understood that while only one processor 32 is depicted for server 30 and only one processor 52 depicted for device 50, each processor 32 and 52 is representative of a multiprocessor arrangement as well as a single processor arrangement. For multiple processor forms, parallel and/or pipeline processing can be utilized as appropriate. Alternatively or additionally, processor 32 and/or processor 52 can be provided in the form of one or more components in a single unit or as multiple units.

Memory 34 and memory 54 can be comprised of one or more units and/or types. These types include solid-state electronic memory, magnetic memory, optical memory, or a combination of these. Memories 34 and 54 include portable memory devices 38 and 58, respectively, that can be an optical disk (such as a CD ROM or DVD); a magnetically encoded hard disk, floppy disk, tape, or cartridge; a nonvolatile solid-state device; and/or a different form as would occur to those skilled in the art. In still other embodiments portable memory devices 38 and/or 58 may be absent.

In one embodiment, at least a portion of each memory 38 and 58 stores operating logic in the form of programming instructions that are executed by the respective processor 32 and 52. Alternatively or additionally, memory 38 and/or 58 can be arranged to store data other than programming instructions. Operating logic for each of processors 52 and 32 is arranged to facilitate performance of various routines, subroutines, procedures, stages, operations, communication, and/or conditionals described hereinafter. This operating logic can be of a dedicated, hardwired variety and/or in the form of programming instructions as is appropriate for the particular processor arrangement. Such logic can be at least partially encoded on device 38 and/or 58 for storage and/or transport to another device. Alternatively or additionally, the operating logic can be in the form of one or more signals carried by a transmission medium, such as network 22.

Devices 50 are generally in the form of specialized data processing terminals present in law enforcement vehicles 40, such as police cruisers, special response vehicles, or the like. Devices 50 are operable to request and receive information by communication through computer network 22. It should be understood that more or fewer devices 50 carried in vehicles 40 can be in communication with computer network 22. In other embodiments of the present application, one or more of devices 50 may be located elsewhere and/or be stationary instead of mobile. Each of devices 50 selectively communicates with server 30 through network 22, and correspondingly can be modeled as a client computer 50a relative to server 30. Correspondingly, server 30 coordinates retrieval of information from data sources 24 and selectively arranges and forwards such information to a requesting device 50. Alternatively or additionally, one or more of devices 50 and server 30 can be participating members of a distributed processing arrangement with one or more processing units being used collectively to execute operating logic according to the present invention.

Data sources 24 are each remotely located relative to one another, server 30, and vehicles 40. Data sources 24 each provide one or more databases of records that are typically of interest to law enforcement. These databases may differ in subject matter and/or applicable region. By way of nonlimiting example, such databases may be applicable to an international, federal, state, county, or municipal region. Alternatively or additionally, a given database can be directed to a designated type of subject matter, such as missing persons (adults and/or children), prison/incarceration records, sex offender records, violent crime offender records, drug offender records, suspected and/or known terrorist records, police records, military records, motor vehicle records, conviction records, arrest records, vehicle operator license records, warrant records, homeland security records, FBI records, immigration records, and/or records of residential addresses and telephone numbers, just to name a few examples. The kind of information provided in a given record can be of any form, including but not limited to alphanumeric text data; one or more facial, fingerprint, or vehicle images; nontextual symbols or graphic data; multimedia information; or the like. Frequently, a given geopolitical region has multiple databases that each relate to a different type of subject matter, some or all of which could be included in data sources 24. Server 30 can be connected locally and/or by dedicated link to one or more data sources of interest as an alternative or addition to one or more remote data sources/databases via network 22.

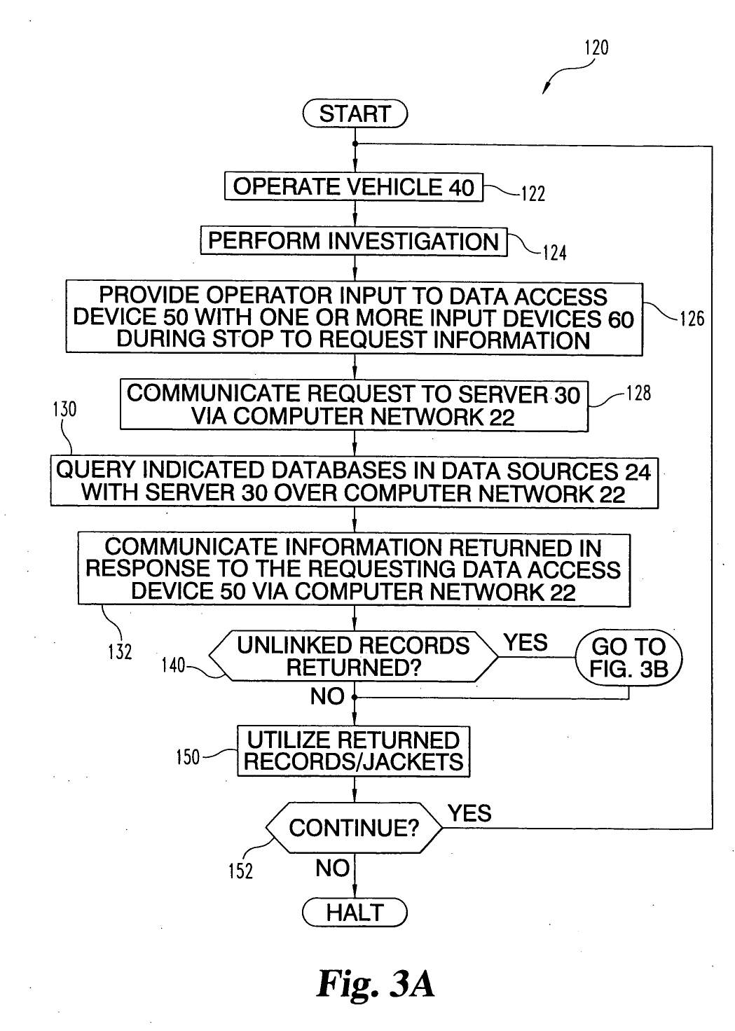

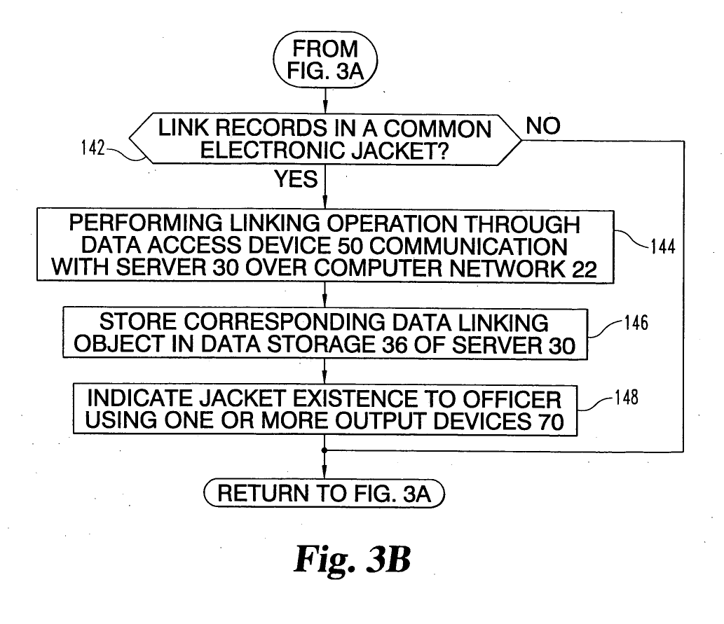

FIGS. 3A and 3B depict data access procedure 120 in flowchart form. Pertinent operations regarding communication between data access device 30, computer network 22, server 30, and data sources 24 are performed in accordance with operating logic of processors 32 and 52 of device 30 and 50, respectively. Such operating logic can be of a dedicated, hardwired form, of a communicated signal form over network 22, and/or in the form of programming instructions stored in one or more of memory 34 and memory 54.

Procedure 120 starts with operation 122. In operation 122, one or more law enforcement officers are on duty in vehicle 40. While on duty, an investigation is performed in operation 124. The investigation may correspond to a traffic stop, a suspicious person on foot, a crime scene, or accident, just to name a few possibilities. During this investigation, operation 126 is executed. In operation 126, operator input is provided to data access device 50 carried in vehicle 40 utilizing one or more of the data input devices 60. Such requests may be in the form of a query that enters a vehicle license plate number, an operator's license number, social security number, the name of a person, the Date of Birth (DOB) of a person, one or more fingerprints of a person with fingerprint reader 66, and/or such other input information as desired.

From operation 126, procedure 120 continues with operation 128. In operation 128, the request generated during operation 126 is communicated from data access device 50 to server 30 via wireless link 42 and computer network 22. From operation 128, operation 130 is next encountered. In operation 130, server 30 executes a search of one or more databases from data sources 24 in accordance with the request from data access device 50. This server query of operation 130 is typically performed over computer network 22. In one form, the particular databases selected can vary as part of the request from the data access device 50. Such databases may be of any type, including, but not limited to those previously described in connection with data sources 24.

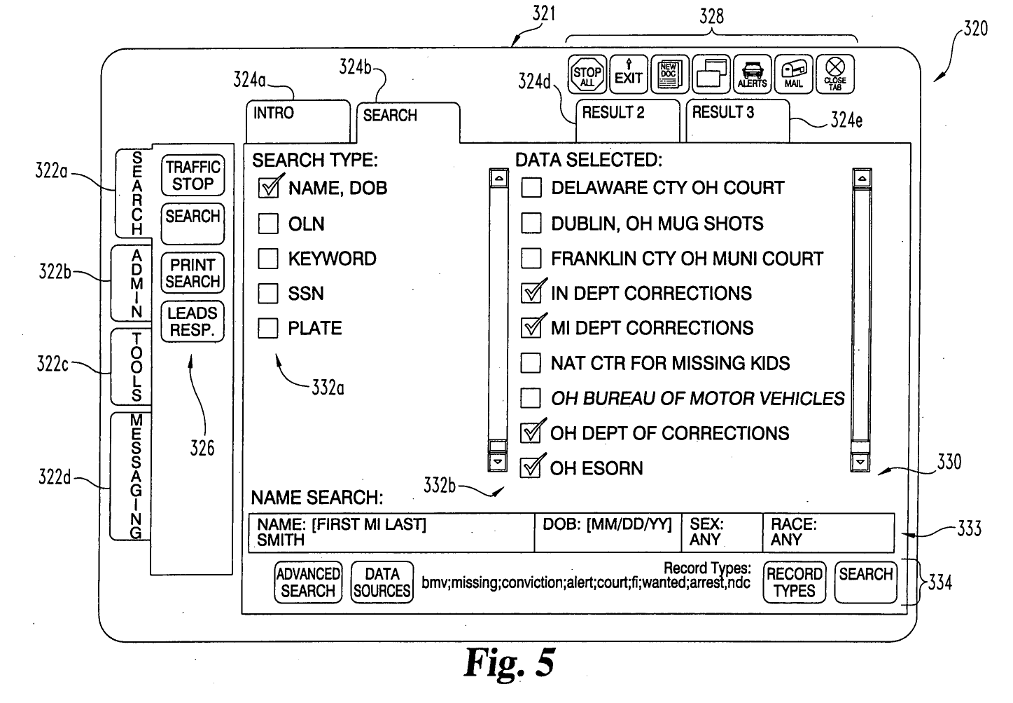

Referring to FIG. 5, one nonlimiting example of a graphic user interface (GUI) display arrangement 320 is shown for entering a data access request and executing a query per operations 126-130. Display arrangement 320 includes a search interface 321 with a number of GUI selection icons, including Input (I/P) device-selectable vertical software tabs 322a, 322b, 322c and 322d. As shown in FIG. 5, search tab 322a has been selected, bringing it to the forefront of display arrangement 320 as search window 330. Search widow 330 includes a number of related input icons in the form of I/P device-selectable software buttons 326 to select more specific features as labeled thereon. The remaining vertical tabs 322b, 322c, and 322d each provide for the selection of a different window (not shown), which respectively are an administrative window, a software tools window, and a messaging window.

With the selection of search window 330 as depicted, a number of horizontal software selection tabs 324a, 324b, 324d, and 324e are shown. Tab 324a corresponds to an introductory window for the data access display arrangement. Tab 324b provides a window to enter search criteria. Tabs 324c-324e correspond to different search results previously generated by executing a search with window 330, which may be alternatively selected. For the search window 330 illustrated in FIG. 5, search criteria include selecting one or more types of input for the search with I/P device-selectable software checkboxes 332a as labeled. Also, search window 330 provides for data source and/or database selection as labeled with I/P device-selectable software checkboxes 332b. As illustrated, the “NAME/DOB” checkbox is selected and a corresponding name of “SMITH” has been entered in the appropriate field of input field block 333 in the bottom portion of window 330.

Display arrangement 320 also includes a number of window-invariant UP device-selectable software tabs 328. Tabs 328 can be used to provide alerts, review email, close/remove tabs, go to email, exit, or the like, as labeled. In addition, software button 328 labeled “NEW DOC” provides a way to enter textual document that can be joined or associated with one or more other records or files. Below input field block 333, other I/P device-selectable software buttons 334 are indicated that correspond to the depicted labeling.

Returning to FIGS. 3A and 3B, procedure 120 continues with operation 132. In response to a server query, information is communicated from server 30 to the requesting data access device 50 via wireless link 42 and computer network 22 in operation 132. From operation 132, conditional 140 is reached. Conditional 140 tests whether multiple records have been returned in operation 132, and if so, whether those records are linked together in a designated manner.

When such linkage is present, it indicates a relationship between a grouping of multiple records based on a specified feature or criteria. In one form, this relationship or grouping is based on the same person being the subject of or listed in each of the records grouped by the linkage. Accordingly, this association of electronic records collectively represent an electronic “jacket” of information applicable to such person. Additionally or alternatively, the linkage can be based on one or more different criteria, such as vehicle license number, a common event/alert grouping, a date/time, or the like, just to name a few possibilities.

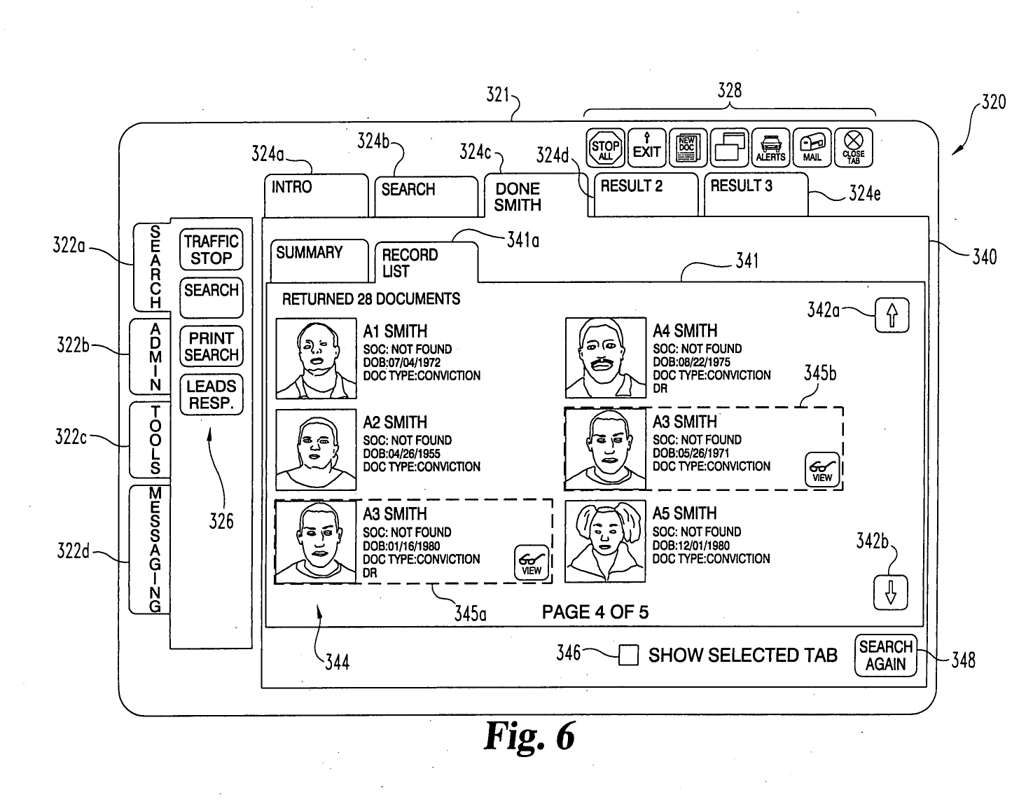

FIG. 6 illustrates GUI display arrangement 320; where like reference numerals refer to like features previously described in connection with FIG. 5. In FIG. 6, search result window 340 is in the forefront of search interface 321, labeled “DONE SMITH,” and has been selected with search result tab 324c. Subordinate to tab 324c, are tab 341a for a “LIST” of results returned, which has been selected and is in the forefront, and a tab for a “SUMMARY” of the results, which has not been selected and is in the background.

The list of results of window 340 shown in FIG. 6 are provided in response to the search input in window 330 of FIG. 5. In window 340, result page 341 is shown that is the fourth of five returned pages of listings under tab 341a for the data sources selected with checkboxes 332b via interface 321 (FIG. 5). For page 341, the I/P device-selectable up and down arrow buttons 342a and 342b, respectively, permit scrolling through the pages returned.

The records accessed through result window 340 are generally designated records 344. Each of records 344 includes an image of the corresponding individual, that Individual's name, data of birth (DOB), and other information as appropriate. For the illustration of FIG. 6, A1 Smith, A2 Smith, A3 Smith, A4 Smith and A5 Smith are shown. Using an I/P device, records 344 that are more specifically designated 345a and 345b, are selected as indicated by a graphic dashed rectangle around each. Both record 345a and 345b are associated with the same name (A3 Smith) and similar images—collectively indicating that records 345a and 345b reference the same individual. For each of selected records 345a and 345b, there is also a software button labeled “VIEW” that can be selected with an I/P device to view detailed record information in a separate window. Window 340 also shows a software checkbox 346 that can be activated with an I//P device to display only those records selected with the dashed rectangle (i.e. records 345a and 345b in this case). Search software button 348 shown in FIG. 6 provides a way to perform another search if activated.

Returning from the example of FIG. 6 to procedure 120 of FIGS. 3A and 3B, if the test of conditional 140 is true, then procedure 120 continues with conditional 142 shown in FIG. 3B. Conditional 142 is a test of whether multiple records, if returned, are desired to be linked. If record linkage between unlinked records is desired as tested by conditional 142, procedure 120 continues with operation 144. In operation 144, a linking operation is performed by the operator through selected input(s) with data access device 50 and corresponding communications with server 30 over computer network 22. Record linkage is defined with a data arrangement that specifies the records to be linked. Such a data arrangement includes any data configuration operable to indicate a relationship between two or more records and provide a way to indicate such linkage in response to an appropriate request. These data arrangements are typically stored in memory 34 of server 30 and include a pointer to the origin of each record in the group. Also, a unique identifier, such as a jacket number, could be assigned to each jacket generated.

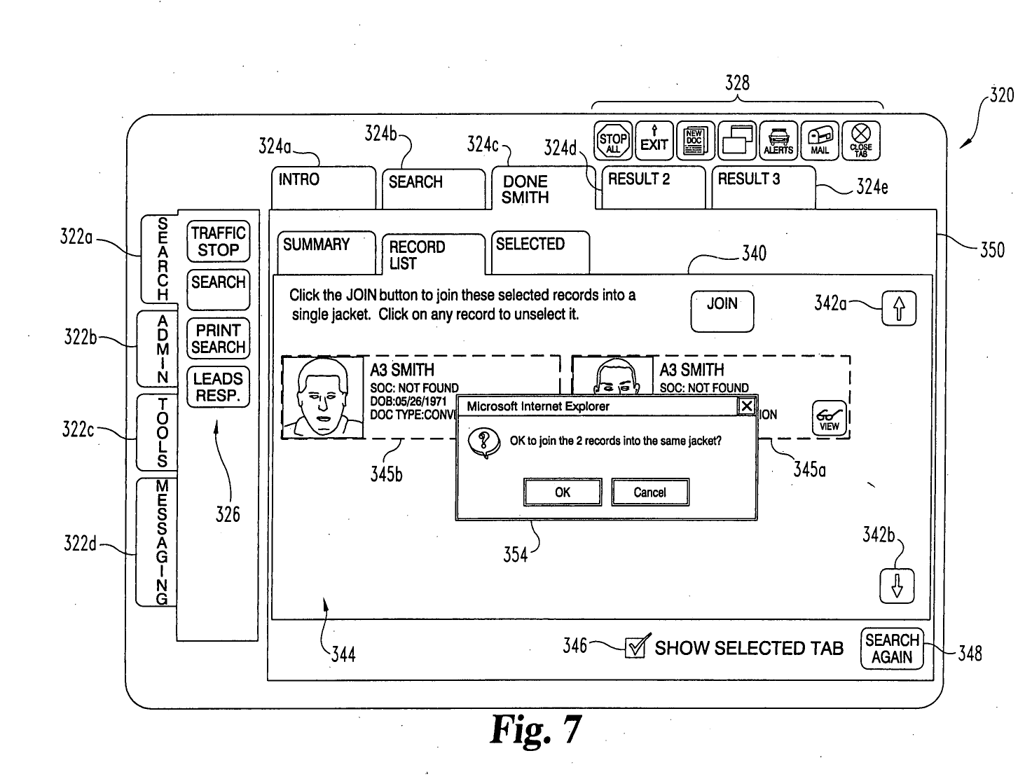

FIG. 7 illustrates GUI display arrangement 320 with linking operation window 350 in the forefront; where like reference numerals refer to like features. Window 350 results from the selection of software checkbox 346 in window 340 shown in FIG. 6. In this nonlimiting example, the two selected records 345a and 345b for A3 Smith are shown in page 351 as a result of the activation of checkbox 346. Also shown on page 351 is a “JOIN” software button 352 to link displayed records. Once button 352 is selected, confirmation window 354 overlays page 351. Window 354 is “OK'd” (approved to proceed) with the OK button or cancelled with the CANCEL button in a standard manner.

Returning to FIG. 3B, procedure 120 continues with operation 146. Operation 146 stores a corresponding data arrangement for the join operation in data storage 36 of server 30 that is retrievable by request with devices 50. This record-linking data arrangement includes the features previously described in connection with operation 144, and can be used to create a GUI form of a “Jacket” record grouping (a “GUI jacket”) for a given individual.

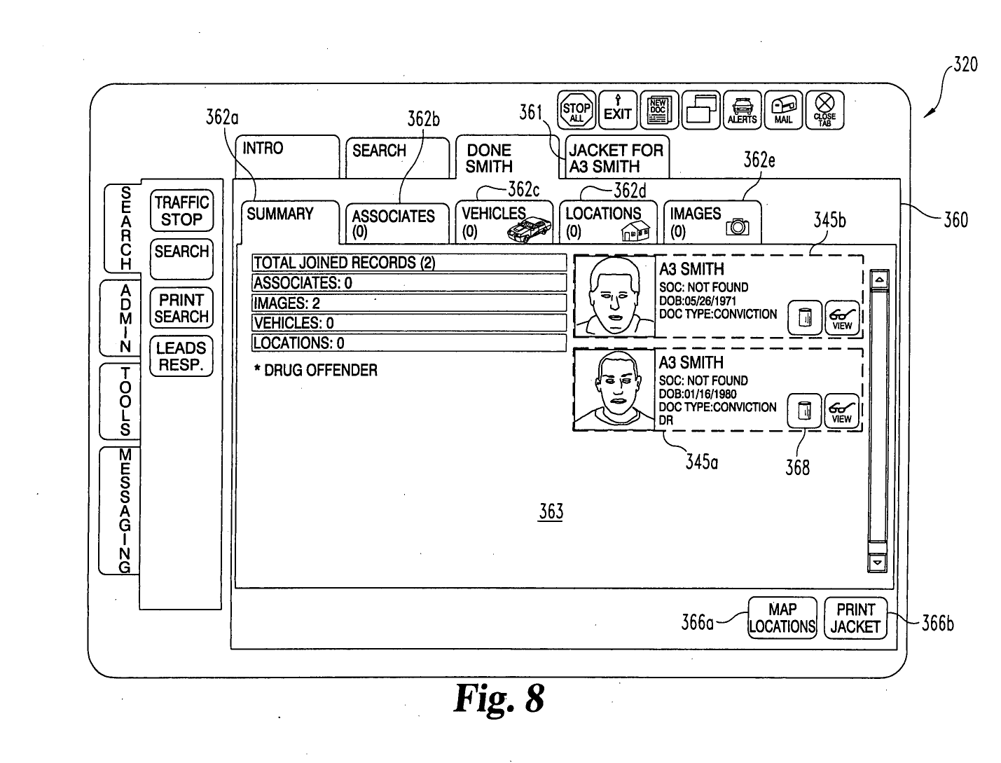

From operation 146, operation 148 provides an indication of the linkage existence to the operator using one or more of output devices 70. In one nonlimiting example, FIG. 8 continues with GUI display arrangement 320 of FIGS. 5-7; where like reference numerals refer to like features. In FIG. 8, GUI jacket window 360 is selected with horizontal software tab 361. Tab 361 was generated as a result of the “OK” button of window 354 shown in FIG. 7. Window 360 displays jacket 363 that has been linked; where the information is categorized in accordance with a group of subordinate horizontal tabs 362a, 362b, 362c, 362d, and 362e. Tab 362a has been selected and provides summary information in window 360, which is the same information as previously shown for the two “A3 Smith” records 345a and 345b of FIGS. 6 and 7. Further, some summarization information is shown. Selection of tab 362b shows any associates that might be known for any of the records joined in jacket 363—in this case none as indicated by “(0)” label. Selection of tab 362c shows any vehicle information (again none indicated by the “(0)” label), and selection of 362d shows any known locations, which are also absent. When one or more locations are known, software button 366a provides a way to generate an electronic location map. Subordinate tab 362e can be selected to view images associated with jacket 363—in this case the two images shown. Software button 366b also provides a way to print jacket information if desired. To remove a given record from a jacket, a “trash can” icon button 368 can be selected to remove the corresponding record.

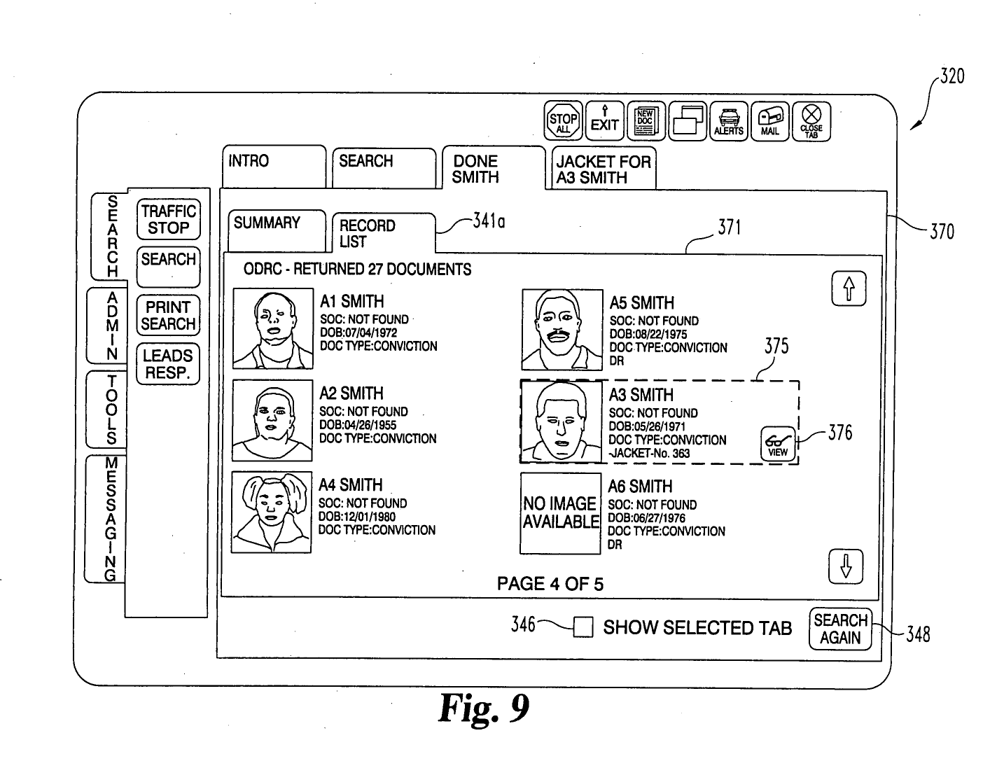

FIG. 9 shows returned records listing window 370 of GUI display arrangement 320 after generation of JACKET NO. 363; where like reference numerals refer to like features described in connection with FIGS. 5-8. In window 370, tab 341a has been selected which presents page 371 with the same records shown in as in page 341 of window 340, except that listing 375 is shown instead of records 345a and 345b. Listing 375 has been user-highlighted with a dashed rectangle as previously described. Consequently, the returned records for page 4 or 5 differ in that the records joined for A3 Smith are shown as a single list entry with the indication of “jacket” status and a respective identification jacket number 363. As a highlighted listing 375, Jacket no. 363 is shown with VIEW button 376. Selection of VIEW button 376 results in the presentation of the same information shown in window 360 of FIG. 8.

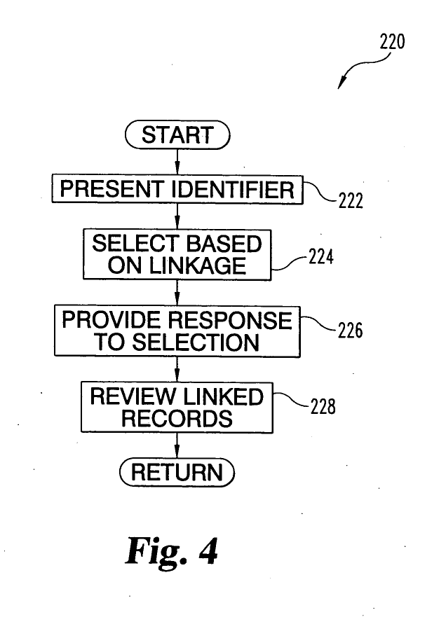

After operation 148, control returns to operation 150 shown in FIG. 3A. In operation 150, any returned records and/or GUI jackets are utilized as needed. FIG. 4 depicts one nonlimiting example of a linked record examination procedure 220 that could be performed during operation 150. Procedure 220 begins with operation 222 in which an identifier indicates the existence of a jacket that links a group of records together for the same subject person. This identifier can be in the form of a graphic symbol or other output, such as JACKET NO. 363 in listing 375 of FIG. 9, to name just one nonlimiting example. In response, the operator provides an input indicative of selection of the linked record group or one or more records in the group in operation 224. Such selection can be executed with a pointing device input relative to a software button, tab, menu or the like; one or more keystrokes; or other input with device 50.

In operation 226, the response to the input of operation 224 includes displaying more information about one or more of the linked records. In one nonlimiting example, such information could be a graphic. structured display of the type shown for GUI display arrangement 320 in FIG. 8. Alternatively, linked records can be cascaded or tiled windows, a scrollable listing, a pull-down menu, or the like. Once the linked records are examined as desired in operation 228, procedure 220 returns to operator 150.

Returning to FIG. 3A after operation 150 is complete, conditional 152 is encountered. Conditional 152 tests whether to continue or not. If the test of conditional 152 is true, procedure 120 loops back to operation 122 to repeat the sequence of operations 122-132. If the test of conditional 152 is negative (false) procedure 120 halts.

Furthermore, it should be appreciated that if the test of conditional 140 is negative, then no records, only a single record, or multiple linked records were returned by operation 132. In such case, procedure 120 bypasses that portion described in connection with FIG. 3B, continuing directly with operation 150. Accordingly, procedure 120 provides a way to retrieve multiple records and group them in a jacket according to the needs of the operator, and to review the linked information as desired. Each linkage is stored in a data arrangement in memory 34 of server 30, and is retrieved in response to requests for information that would have returned one or more of the linked records prior to grouping them together.

Records can be linked together based on information other than being directed to the same person. As an addition or alternative to procedure 120, the ability to link records among multiple people in a group is also provided. Such a multiperson linkage, along with any records or jackets for each of these people can be utilized to provide an alert when a possible threat is posed or suspected. For example, providing an alert that links available records for each member of a suspicious group noticed near an airport may be useful in an antiterrorism investigation. In another example, an event such as a bank robbery by a group of individuals could be the subject of an alert that groups all available records together for any suspects, vehicles, or other data entries known or suspected to be associated with the event. Indeed, there are many other variations and alterations within the scope of such features.

A further embodiment of the present application comprises: providing an input to a data access device to request information about a person for a law enforcement investigation; in response to this input, receiving a number of records corresponding to the person; providing a data arrangement that links a group of the records together; presenting an identifier for the data arrangement with the data access device; and selectively accessing at least one member of the group linked by the data arrangement. The data access device can be a desktop computer, a laptop computer, a handheld device, can be stationary or mobile, and/or can communicate wirelessly or by wired connection. The records can be provided from a number of remote databases, with one or more being a law enforcement record type. Other embodiments include a system operable to perform in this manner and a device carrying logic executed with a processor to perform in this manner.

Another embodiment includes: receiving a plurality of requests directed to a law enforcement investigation of a respective one of a number of people; providing a respective one of a corresponding number of data objects that are each specific to one of the people; linking two or more records specific to each person in a respective one of the data objects; presenting an identifier for the respective one of the data objects to a user through a data access device; and selecting one or more records linked by the respective one of the data objects. The data access device can be a desktop computer, a laptop computer, a handheld device, can be stationary or mobile, and/or can communicate wirelessly or by wired connection. The records can be provided from a number of remote databases, with one or more being a law enforcement record type. Other embodiments include a system operable to perform in this manner and a device carrying logic executed with a processor to perform in this manner.

While the invention has been illustrated and described in detail in the drawings and foregoing description, the same is to be considered as illustrative and not restrictive in character, it being understood that only selected embodiments have been shown and described and that all changes, modifications and equivalents that come within the spirit of the inventions described heretofore and/or defined by the following claims are desired to be protected.

1. A method, comprising:
a law enforcement officer selecting a person to investigate;
to request information about the person, providing an input to a data access device carried in a law enforcement vehicle;
in response to the input, receiving a number of records corresponding to the person, the records each being provided from a different one of a number of remote databases;
providing a data arrangement that links a group of the records together;
presenting an identifier for the data arrangement to the law enforcement officer with the data access device; and
selectively accessing at least one member of the group linked by the data arrangement.

2. The method of claim 1, which includes providing the input with a fingerprint reader.

3. The method of claim 1, wherein one of the records is a vehicle record and another of the records is a criminal record.

4. The method of claim 3, wherein a further one of the records is a military record.

5. The method of claim 1, which includes displaying an image of the person from one of the records in the group.

6. The method of claim 1, wherein the input is in the form of a query of the databases.

7. The method of claim 1, which includes communicating between the data access device and a server over a computer network including the internet, the server storing the data arrangement.

8. The method of claim 7, which includes:
after the accessing, resuming patrol with the vehicle;
performing a traffic stop with the vehicle after the resuming;
in response to the traffic stop, retrieving a different group of records corresponding to a different person, the different group of records each being from a respective one of the remote databases and being linked by a different corresponding data arrangement stored by the server.

9. A method, comprising:
with a data access device carried in a law enforcement vehicle, receiving a plurality of requests each directed to investigation of a respective one of a number of people;
in response to each of the requests, providing a respective one of a corresponding number of data arrangements, the respective one of the data objects being specific to the respective one of the people;
linking two or more records specific to the respective one of the people in the respective one of the data arrangements, the two or more records each being provided from a different one of a number of databases;
presenting an identifier for the respective one of the data arrangements to a user through the data access device; and
selecting one or more of the records linked by the respective one of the data arrangements.

10. The method of claim 9, which includes providing one or more of the requests as an input from a fingerprint reader.

11. The method of claim 9, wherein one of the records includes at least one of vehicle information, conviction information, and military information.

12. The method of claim 9, which includes displaying an image of the person from one of the records in the group.

13. The method of claim 9, which includes communicating between the data access device and a server over a computer network including the internet, the server storing the data object.

14. The method of claim 13, which includes providing an alert with the data access device that links a group of people together.

15. A device, comprising: logic carried with the device that is executable by a processor to: (a) respond to each of a plurality of requests, the requests each being directed to investigation of a respective one of a number of people; (b) provide a respective one of a corresponding number of data arrangements, the respective one of the data arrangements being specific to the respective one of the people; (c) link two or more records specific to the respective one of the people in the respective one of the data arrangements, the two or more records each being provided from a different one of a number of databases; (d) provide an identifier for the respective one of the data arrangements to a user through a data access device carried in a law enforcement vehicle; and (e) respond to input from the data access device by providing one or more of the records linked in the respective one of the data arrangements.

16. The device of claim 15, wherein the device is in the form of a portable computer-accessible memory and the logic is in the form of programming instructions encoded on the disk.

17. The device of claim 16, wherein the portable computer-accessible memory is in the form of a portable disk.

18. The device of claim 15, wherein the device is in the form of at least a portion of a computer network and the logic is in the form of encoded signals carried with the computer network.

19-24. (canceled)

25. A method, comprising:
with a data access device carried in a law enforcement vehicle, receiving a plurality of requests each directed to investigation of a respective one of a number of people;
in response to each of the requests, providing a respective one of a corresponding number of data arrangements, the respective one of the data arrangements being specific to the respective one of the people;
linking two or more records specific to the respective one of the people in the respective one of the data arrangements, the two or more records each being provided from a different one of a number of databases;
presenting an identifier for the respective one of the data arrangements to a user through the data access device;
selecting one or more of the records linked by the respective one of the data arrangements, one of the records including at least one of vehicle information, conviction information, and military information;
displaying an image of the person from one of the records in the group; and
providing an alert with the data access device that links a group of people together.

26. The method of claim 25, which includes communicating between the data access device and a server over a computer network including the internet, the server storing the respective one of the data arrangements.
